(19) United States
(12) Patent Application Publication
(10) Pub. No.: US 2017/0087039 A1
(43) Pub. Date: Mar. 30, 2017

(54) ELECTRIC BED FRAME

(71) Applicant: CHUAN-HANG SHIH, LU-KANG TOWN (TW)

(72) Inventor: CHUAN-HANG SHIH, LU-KANG TOWN (TW)

(21) Appl. No.: 14/867,520

(22) Filed: Sep. 28, 2015

(51) Int. Cl. A61G 7/018; A61G 7/015

(52) U.S. Cl. CPC A61G 7/018; A61G 7/015

(57) ABSTRACT

An electric bed frame includes a retaining frame, a back supporting frame pivotally connected to the retaining frame, a thigh supporting frame having a front end pivotally connected to the retaining frame, a lower leg supporting frame having a front end pivotally connected to a rear end of the thigh supporting frame, and a first link rod having a front end pivotally connected to the thigh supporting frame, and a rear end slidably disposed in a slide coupling part of the retaining frame. An actuator has two ends pivotally connected to the back supporting frame and the retaining frame, respectively. A linking member has a front end connected to the actuator or a pushing member of the back supporting frame, and a rear end connected to the first link rod.

### BACKGROUND

1. Technical Field

The present disclosure relates to an electric bed frame, more particularly to an electric bed frame equipped with a single actuator.

2. Description of Related Art

An electric bed frame generally includes a retaining frame, a back supporting frame pivotally connected to the retaining frame, a thigh supporting frame pivotally connected to the retaining frame, and a lower leg supporting frame pivotally connected to the thigh supporting frame. The back supporting frame can be pivotally swung upwardly to lift a user's back, so that the user can breathe more smoothly, or take a meal or reading on the bed conveniently. The thigh supporting frame and the lower leg supporting frame can be pivotally swung upwardly together to bend the user's knee or lift the user's lower limbs for relaxing swelling. A conventional electric bed frame utilizes two actuators to separately drive the back supporting frame and the thigh supporting frame which acts simultaneously with the lower leg supporting frame. However, two actuators cause higher cost for the manufacturer and consume more power, or cause more using complexity because the user must control two actuators separately. Therefore, how to make the electric bed frame capable of lifting the back supporting frame and the thigh supporting frame with the advantages of low cost and easy operation becomes an important issue.

### SUMMARY

In order to solve the above-mentioned defects, an objective of the present disclosure is to provide an electric bed frame having advantages of inexpensive cost and easy operation.

In order to achieve the objective, the present disclosure provides an electric bed frame which includes a head portion at a front end thereof, a foot portion at a rear end thereof, a retaining frame, a back supporting frame, a thigh supporting frame, a lower leg supporting frame, a first link rod, an actuator and a linking member. The retaining frame has a slide coupling part extending longitudinally. The back supporting frame has a main body provided with a rear end pivotally connected to the retaining frame, and a pushing member extending downwardly from the main body. The thigh supporting frame has a front end pivotally connected to the retaining frame. The lower leg supporting frame has a front end pivotally connected to a rear end of the thigh supporting frame. The first link rod has a front end pivotally connected to the thigh supporting frame, and a rear end slidably disposed in the slide coupling part of the retaining frame. The actuator has a changeable length and is provided with a front end pivotally connected to the pushing member of the back supporting frame through a pivot, and a rear end pivotally connected to the retaining frame. The linking member is connected between the actuator and the first link rod, or between the pushing member and the first link rod.

By means of the above-mentioned design of adopting one single actuator and associated members thereof to replace the conventional dual-actuator structure, the present disclosure can provide an electric bed frame having advantages of inexpensive cost and easy operation.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a perspective view of a first embodiment of the present disclosure.

FIG. 2 is a perspective view of the first embodiment when viewed from another angle, and a part of a retaining frame is omitted in FIG. 2.

FIG. 3 is a schematic view of a first state of the first embodiment of the present disclosure.

FIG. 4 is a schematic view of a second state of the first embodiment of the present disclosure.

FIG. 5 is a schematic view of a third state of the first embodiment of the present disclosure.

FIGS. 6-8 are schematic views of parts of the second embodiment of the present disclosure, respectively illustrating first, second and third states thereof.

FIG. 9 is a schematic view of a part of a third embodiment of the present disclosure, illustrating a first state of the third embodiment.

FIG. 10 is a schematic view of a part of a fourth embodiment of the present disclosure, illustrating a first state of the fourth embodiment.

FIG. 11 is a schematic view of a part of a fifth embodiment of the present disclosure, illustrating a first state of the fifth embodiment.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

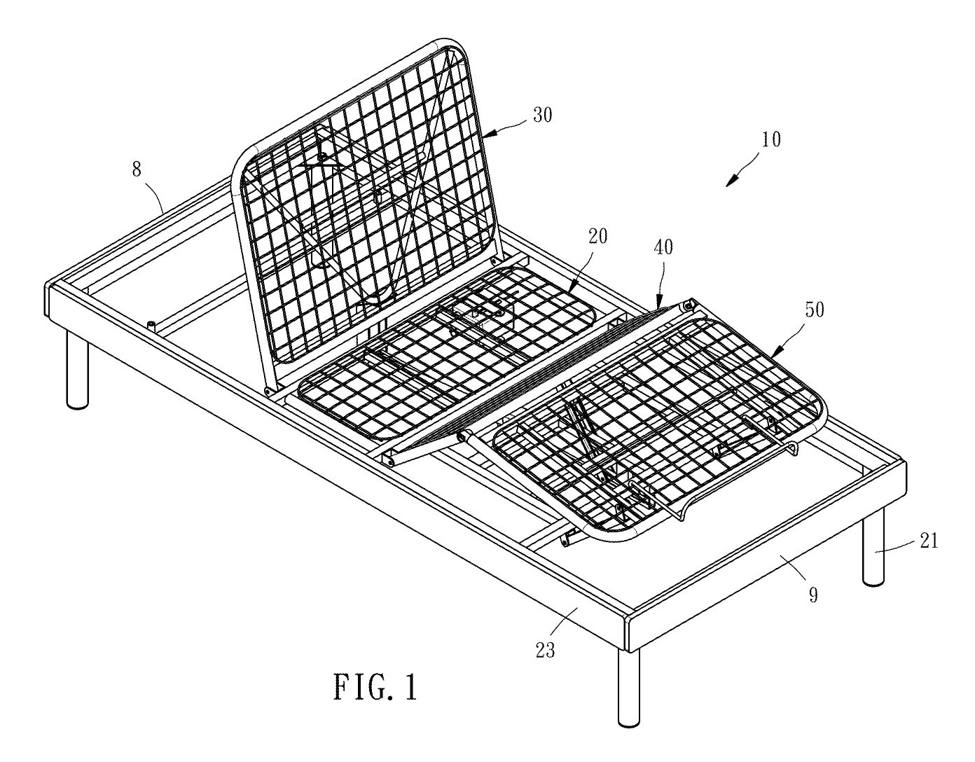

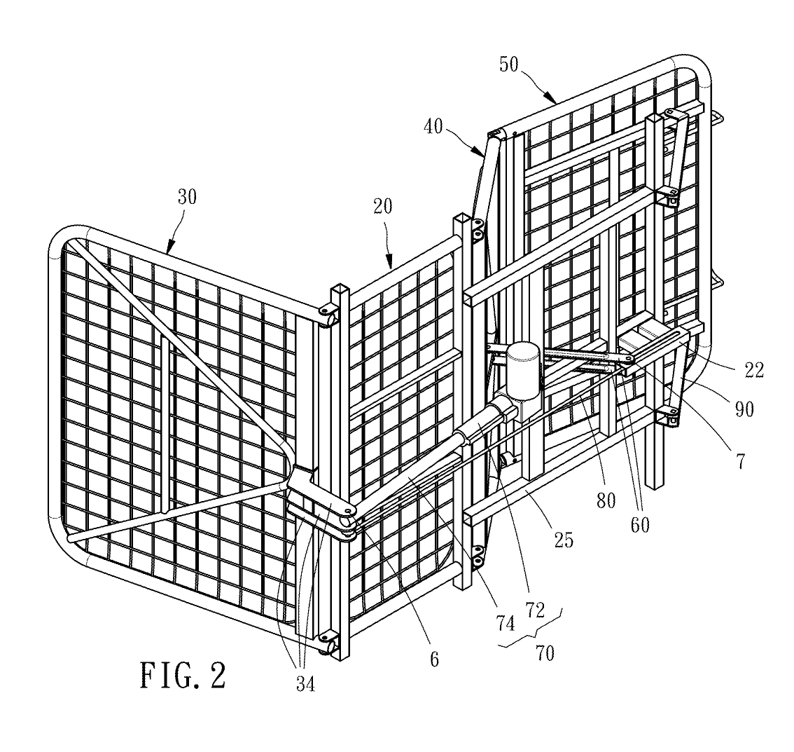

Please refer to FIG. 1 through FIG. 5. The first embodiment of an electric bed frame 10 of the present disclosure has a head portion 8 located at the front end thereof and a foot portion 9 located at the rear end. Further, the electric bed frame 10 includes a retaining frame 20, a back supporting frame 30, a thigh supporting frame 40, a lower leg supporting frame 50, two first link rods 60, an actuator 70, a linking member 80, and two second link rods 90.

The retaining frame 20 is defined in this disclosure as a part of the electric bed frame 10 not driven by the actuator 70 to change its position, and includes four bed legs 21, a bed frame 23 and a plurality of support brackets 25. The retaining frame 20 has a slide coupling part 22 which extends longitudinally, i.e. extends in a longitudinal direction extending from the front end towards the rear end, and has a sliding slot 24. The sliding slot 24 extends longitudinally and has a front end 242 and a rear end 244.

The back supporting frame 30 has a main body 32 and three pushing members 34. The main body 32 is used to support a user's back and has a rear end 324 pivotally connected to the retaining frame 20. Each of the pushing members 34 extends from the main body 32 downwardly and has a bottom end 344.

The thigh supporting frame 40 has a front end 42 pivotally connected to the retaining frame 20, and a rear end 44. The thigh supporting frame 40 is used to support the user's thighs.

The lower leg supporting frame 50 has a front end 52 pivotally connected to the rear end 44 of the thigh supporting frame 40. The lower leg supporting frame 50 is adapted for supporting the user's lower legs.

Each of the first link rods 60 has a front end 62 pivotally connected to the thigh supporting frame 40, and a rear end 64. A pin 7 is disposed between the rear ends 64 of the two first link rods 60 and slidably inserted into the sliding slot 24.

The actuator 70 has an actuating cylinder 72 and a shaft 74 retractably disposed inside the actuating cylinder 72. A rear end 724 of the actuating cylinder 72 is pivotally connected to one support bracket 25 of the retaining frame 20, and a front end 742 of the shaft 74 is linked with the pushing members 34 of the back supporting frame 30 via a pivot 6. In this embodiment, the front end of the actuator 70 is the front end 742 of the shaft 74, and the rear end of the actuator 70 is the rear end 724 of the actuating cylinder 72.

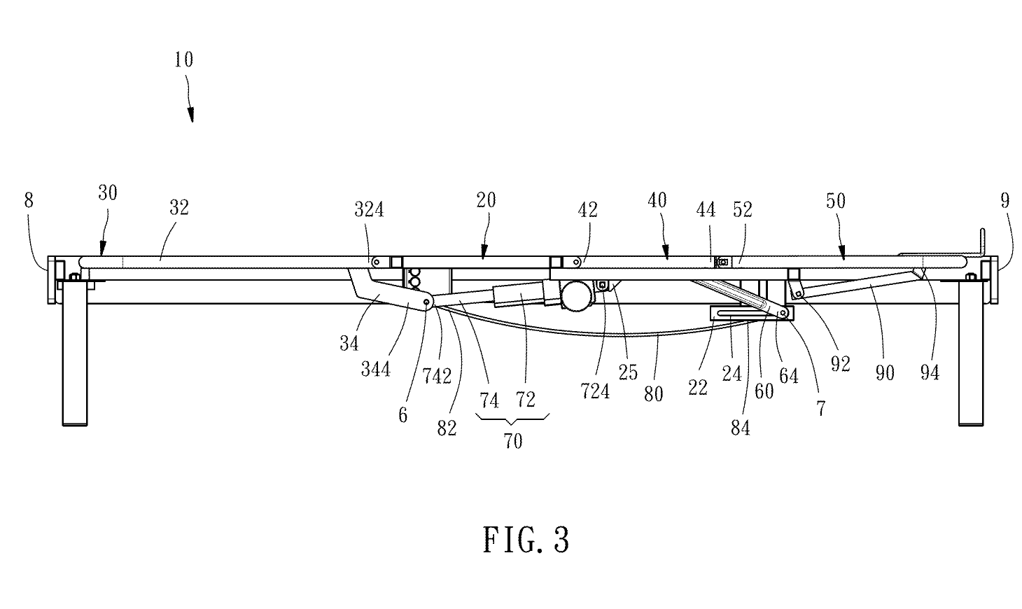

The linking member 80 has a front end 82 linked with the pivot 6, and a rear end 84 linked with the first link rods 60 via the pin 7. The linking member 80 is flexible, and the length of the linking member 80 is defined as a straight-line distance between the front end 82 of the linking member 80 and the rear end 84 of the linking member 80 when the linking member 80 is fully stretched. A first distance is defined as a straight-line distance between the rear end 64 of the first link rod 60 and the front end of the actuator 70 while the electric bed frame 10 is unfolded. As shown in FIG. 3, the length of the linking member 80 is larger than the first distance, such that the linking member 80 is loosen and drooped while the electric bed frame 10 is unfolded. In this embodiment, the linking member 80 is a steel rope.

Each of the second link rods 90 has a rear end 94 pivotally connected to a rear section of the lower leg supporting frame 50, and a front end 92 pivotally connected to the retaining frame 20.

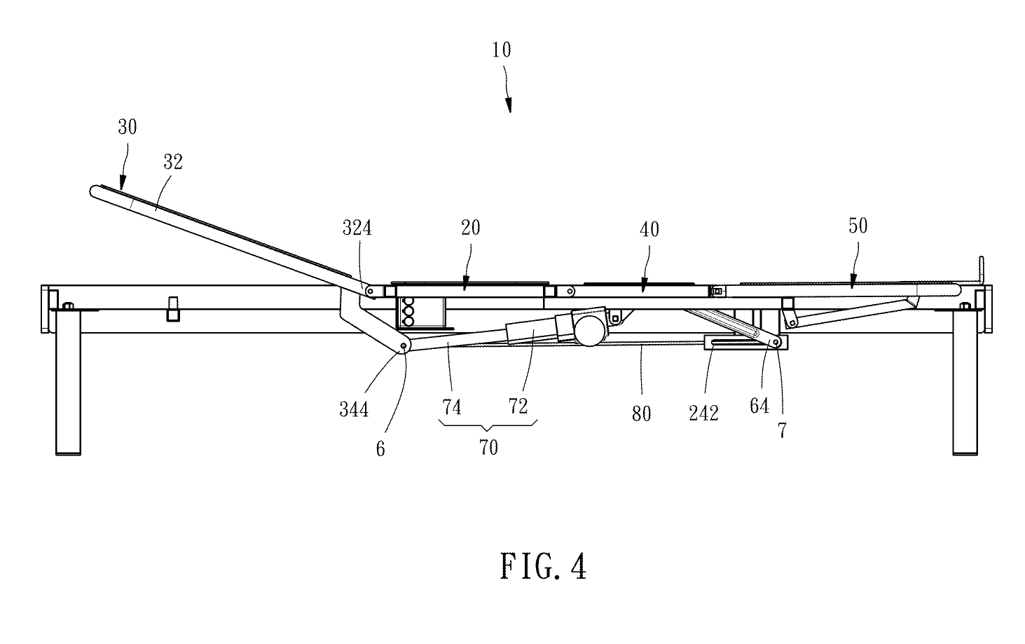

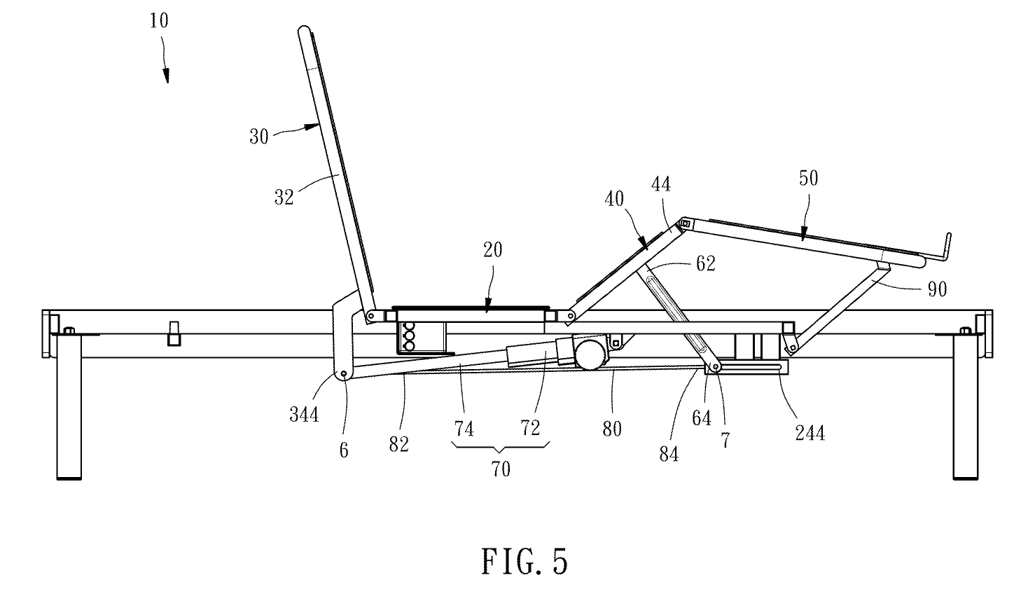

The operation of the electric bed frame 10 of the first embodiment is illustrated below. Please refer to FIG. 3. The electric bed frame 10 has a first state where the back supporting frame 30, the thigh supporting frame 40 and the lower leg supporting frame 50 are positioned in flat manners on the retaining frame 20, at this time the length of the actuator 70 is relatively shorter, the linking member 80 is loosened and drooped, and the pin 7 is located at the rear end 244 of the sliding slot 24. In the first state of the electric bed frame 10, the user can lie flat. When the user wants to lift his/her head by the bed, the user can control the actuator 70 to extend to change the electric bed frame 10 into a second state, as shown in FIG. 4. In the process of operating the electric bed frame 10 from the first state to the second state, the front end of the actuator 70, i.e. the front end 742 of the shaft 74, is moved forwardly to push the bottom ends 344 of the pushing members 34, to make the main body 32 of the back supporting frame 30 pivotally swing upwardly, so that the lifted back supporting frame 30 can support lifting of the user's head. In addition, through the pivot 6, the front end 82 of the flexible linking member 80 is simultaneously acted by the front end of the actuator 70 to move forwardly to cause that the linking member 80 is gradually tensed but the rear end 84 of the linking member 80 still stays at an original position thereof, so that the first link rods 60 are not moved and the thigh supporting frame 40 and the lower leg supporting frame 50 are still positioned flat on the retaining frame 20. When the user wants to make his/her back upright and bend his/her knees by bed, the user can control the actuator 70 to extend longer to change the electric bed frame 10 into a third state, as shown in FIG. 5. In the process of operating the electric bed frame 10 from the second state to the third state, the front end of the actuator 70 (the front end 742 of the shaft 74) and the front end of the linking member 80 are moved more forwardly together to push the bottom ends 344 of the pushing members 34, so as to make the main body 32 of the back supporting frame 30 pivotally swing more upwardly, and the tensed linking member 80 will pull the pin 7 forwardly to the front end 242 of the sliding slot 24, and the rear ends 64 of the first link rods 60 are also pulled to the front end 242 of the sliding slot 24, and meanwhile the front ends 62 of the first link rods 60 push the thigh supporting frame 40 to make the thigh supporting frame 40 pivotally swing upwardly, the front end 52 of the lower leg supporting frame 50 is also lifted simultaneously, and correspondingly the second link rods 90 are also pivotally swung upward to support the rear section of the lower leg supporting frame 50. On the other hand, when the user controls the actuator 70 to shorten its length, the electric bed frame 10 is changed from the third state to the second state; if the user further controls the actuator 70 to shorten its length more, the electric bed frame 10 is changed from the second state to the first state.

Therefore, by disposal of one single actuator 70 and associated members, the user can just control the actuator 70 to swing the back supporting frame 30 independently, and further swing the back supporting frame 30, the thigh supporting frame 40 and the lower leg supporting frame 50 simultaneously. The present disclosure can provide an electric bed frame 10 with advantages of inexpensive cost and easy control both.

Based on spirit of the present disclosure, the electric bed frame 10 can be implemented in variations, for example, the actuator 70 can be implemented by other device, such as a pneumatic cylinder, a hydraulic cylinder, linear motor and so on; the positions of the actuating cylinder 72 and the shaft 74 of the actuator 70 can be exchanged, that is, the shaft 74 is pivotally connected to the retaining frame 20 and extends backwardly from the actuating cylinder 72, and the actuating cylinder 72 is pivotally connected to the pushing members 34 of the back supporting frame 30. In other words, as long as an actuator has a changeable length and has a rear end pivotally connected to the retaining frame 20 and a front end pivotally connected to the pushing members 34 of the back supporting frame 30, such actuator can be applied to the electric bed frame 10 of the present disclosure.

The numbers of the first link rods 60 and the pushing members 34 are not limited to that of the first embodiment, and more first link rods 60 and pushing members 34 can be used to enhance the structural strength of the electric bed frame 10. In addition, even if the electric bed frame 10 has only one single first link rod 60 and one single pushing member 34 can also achieve the objective of the present disclosure.

The second link rod 90 can be one in number, and even the electric bed frame without the second link rod 90 can also achieve the objective of the present disclosure. For example, while the front end of the lower leg supporting frame 40 is lifted by the thigh supporting frame 50, the rear section of the lower leg supporting frame 40 is not lifted because of no support of the second link rod 90, such that the user's knee joint is bent more but such electric bed frame still has the effects of inexpensive cost and easy control.

The slide coupling part 22 is used to make the rear end 64 of the first link rod 60 longitudinally movable by acting with the linking member 80, and other technologies capable of slidably disposing the rear end of the first link rod 60 in the slide coupling part 22 can replace the sliding slot 24 and the pin 7. For example, the slide coupling part 22 may be configured having a longitudinal track, and at least one roller disposed at the rear end of the first link rod is slidable along the track.

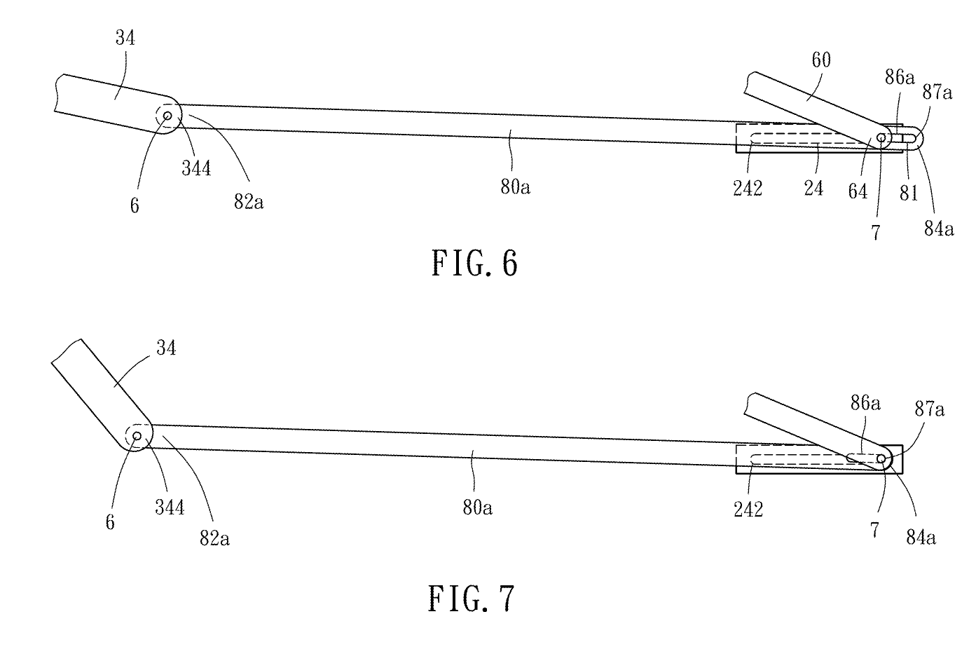

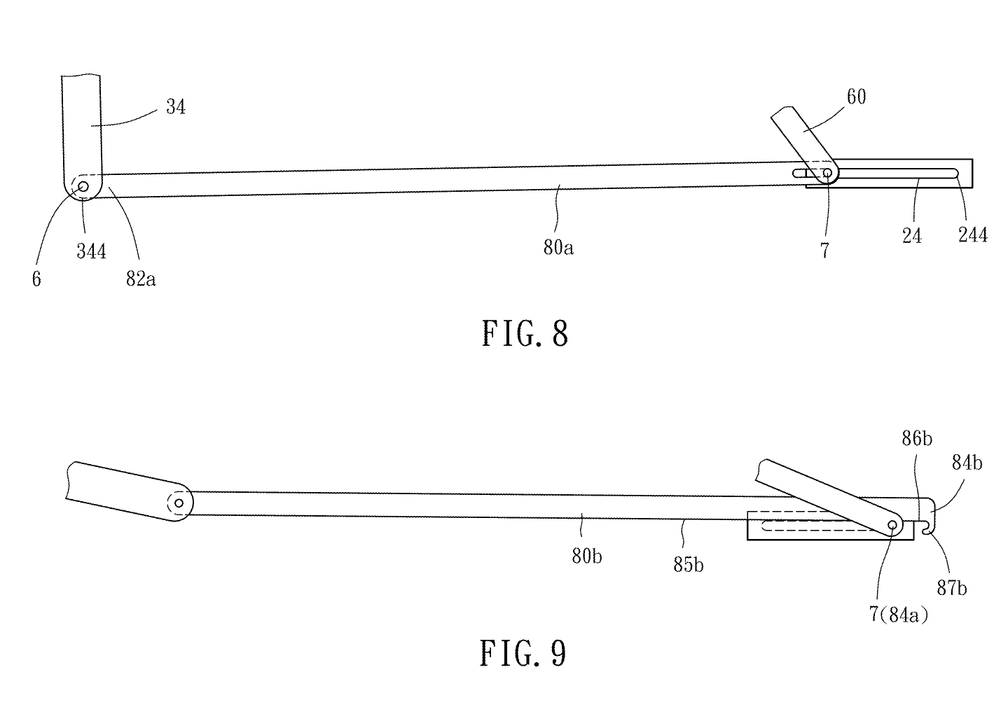

Alternately, in other embodiments, the linking member can be non-flexible, such as wooden rod, aluminum bar, and so on. Please refer to FIG. 6 through FIG. 8, which show a second embodiment of the present disclosure. The second embodiment is similar to the first embodiment, but the difference between them is that the linking member 80a is an aluminum bar and has a first sliding slot 81 at a rear section thereof. An upper edge of the first sliding slot 81 is defined as a first abutting part 86a which extends longitudinally, abutted against the pin 7 and slidable relative to the pin 7. The rear end of the first sliding slot 81 is defined as a first engagement part 87a which is positioned at the rear end of the first abutting part 86a. Please refer to the FIG. 6. While the electric bed frame is unfolded, that is in the first state, the pin 7 is located at the front end of the first abutting part 86a. Please refer to FIG. 7. While the actuator 70 extends to push the pushing members 34 of the back supporting frame 30, the linking member 80a pivotally connected to the bottom end 344 of the pushing members 34 is pulled forwardly, such that the first abutting part 86a is slid forwardly relative to the pin 7 until the first engagement part 87a is engaged with the pin 7 and, at this time, the electric bed frame is in the second state. Please refer to the FIG. 8. When the actuator 70 extends longer to pull the linking member 80a more forwardly, the first engagement part 87a drives the pin 7 to move forwardly along the sliding slot 24 of the retaining frame 20 until the pin 7 reaches the front end 242 of the sliding slot 24 (as shown in FIG. 8) and, at this time, the electric bed frame is in the third state.

Alternately, the first abutting part and the first engagement part can be in other types, such as a third embodiment shown in FIG. 9. In the third embodiment, the first abutting part 86b is located at a rear end 84b of a bottom side 85b of the linking member 80b and abutted against the pin 7, and the first engagement part 87b is located at the rear end of the first abutting part 86b and has a hook shape. While the linking member 80b is moved forward, the first engagement part 87b can be engaged with the pin 7 and further move the pin 7 forwardly together.

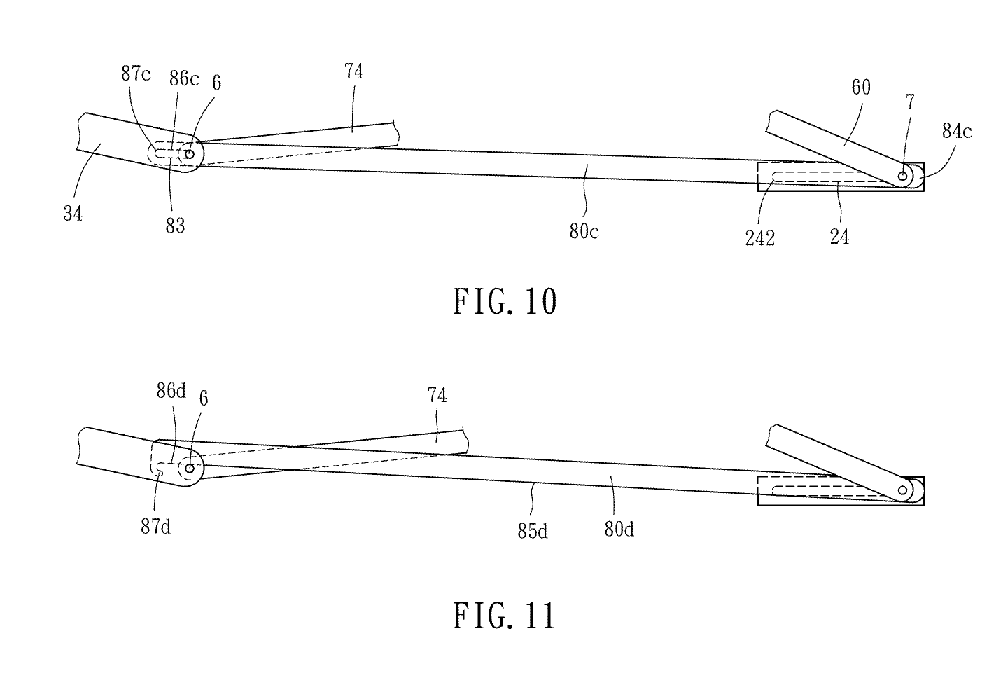

The linking member can be in other types, such as a fourth embodiment shown in FIG. 10. In the fourth embodiment, the linking member 80c has a second sliding slot 83 at a front end thereof. An upper side of the second sliding slot 83 is defined as a second abutting part 86c which extends longitudinally, abutted against the pivot 6 and slidable relative to the pivot 6. A front end of the second sliding slot 83 is defined as a second engagement part 87c which is positioned at the front end of the second abutting part 86c. In the fourth embodiment, when the electric bed frame is unfolded, that is in first state, the pivot 6 is located at the rear end of the second abutting part 86c. While the shaft 74 of the actuator 70 extends, the pushing members 34 of the back supporting frame 30 is driven to pivotally swing and the pivot 6 is pushed to move toward the second engagement part 87c until the pivot 6 and the second engagement part 87c are engaged with each other and, at this time, the electric bed frame of the fourth embodiment is in the second state. While the shaft 74 of the actuator 70 extends more, the rear end 84c of the linking member 80c drives the pin 7 to move forwardly along the sliding slot 24 until the pin 7 is abutted against the front end 242 of the sliding slot 24, such that the first link rod 60 drives the thigh supporting frame 40 to pivotally swing upwardly and, at this time, the electric bed frame of the fourth embodiment is in the third state.

Alternately, the second abutting part and the second engagement part can be in other types, such as a fifth embodiment shown in FIG. 11. In the fifth embodiment, the second abutting part 86d is located at the bottom side 85d of the linking member 80d and extends longitudinally and abutted against the pivot 6. The second engagement part 87d is positioned at the front end of the second abutting part 86d and has a hook shape. While the pivot 6 is moved forward, the pivot 6 will be engaged with the second engagement part 87d to drive the linking member 80d to move forwardly.

In other embodiments, the linking member can be non-flexible metal rod which does not have aforesaid first and second abutting parts 86a, 86b, 86c and 86d, and aforesaid first and second engagement parts 87a, 87b, 87c and 87d. While the back supporting frame 30 is being pivotally swung upwardly, the thigh supporting frame 40 and the lower leg supporting frame 50 are pivotally swung upwardly at the same time (that is the third state), it means that such electric bed frame just has the first and third states but no second state; in other words, the actuator 70 of the electric bed frame can make the back supporting frame 30, the thigh supporting frame 40 and the lower leg supporting frame 50 pivotally swing upwardly at the same time, so the electric bed frame has the advantages of inexpensive cost and easy operation.

Based on spirit of the present disclosure, the electric bed frame can be implemented in variations, for example, the front end of the linking member is not limited to link or fasten with the pivot 6, and the rear end of the linking member is not limited to connect with the first link rod 60 through the pin 7. In practice, the present disclosure just requires that the front end of the linking member is linked or fastened with the retractable part of the actuator 70 (such as the shaft 74); alternately, the front end of the linking member can be linked or fastened with a part of the pushing member 34 which is not linked with the main body 32; and the rear end of the linking member is linked or fastened with a part of the first link rod 60 which is not pivotally connected to the thigh supporting frame 40.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An electric bed frame having a front end with a head portion and a rear end with a foot portion and defining a longitudinal direction extending from the front end towards the rear end, the electric bed frame comprising:
a retaining frame having a slide coupling part extending along the longitudinal direction;
a back supporting frame having a main body and a pushing member, the main body having a rear end pivotally connected to the retaining frame, and the pushing member extending from the main body downwardly;
a thigh supporting frame having a front end pivotally connected to the retaining frame, and a rear end;
a lower leg supporting frame having a front end pivotally connected to the rear end of the thigh supporting frame;
a first link rod having a front end pivotally connected to the thigh supporting frame, and a rear end slidably disposed in the slide coupling part of the retaining frame;
an actuator having a front end pivotally connected to the pushing member of the back supporting frame through a pivot, and a rear end pivotally connected to the retaining frame, wherein a length of the actuator is changeable; and
a linking member connected between the actuator and the first link rod, or between the pushing member and the first link rod.

2. The electric bed frame as claimed in claim 1, wherein the linking member is flexible.

3. The electric bed frame as claimed in claim 1, wherein the slide coupling part has a sliding slot extending along the longitudinal direction, and the rear end of the first link rod is disposed with a pin slidably disposed in the sliding slot.

4. The electric bed frame as claimed in claim 3, wherein the linking member is connected to the first link rod through the pin.

5. The electric bed frame as claimed in claim 4, wherein the linking member has a first abutting part extending along the longitudinal direction and abutted against the pin and slidable relative to the pin, and a first engagement part located at a rear end of the first abutting part and engageable with the pin.

6. The electric bed frame as claimed in claim 1, wherein the linking member has a second abutting part extending along the longitudinal direction and abutted against the pivot and slidable relative to the pivot, and a second engagement part located at a front end of the second abutting part and engageable with the pivot.

7. The electric bed frame as claimed in claim 1, wherein the linking member has a front end linked with the front end of the actuator or a bottom end of the pushing member.

8. The electric bed frame as claimed in claim 1, wherein the linking member has a front end linked to the pivot.

9. The electric bed frame as claimed in claim 1, wherein the actuator has an actuating cylinder and a shaft retractably disposed in the actuating cylinder.

10. The electric bed frame as claimed in claim 1, further comprising a second link rod having a rear end pivotally connected to the lower leg supporting frame, and a front end pivotally connected to the retaining frame.
